(19) United States
(12) Patent Application Publication
(10) Pub. No.: US 2012/0201362 A1
(43) Pub. Date: Aug. 9, 2012

(54) POSTING TO SOCIAL NETWORKS BY VOICE

(75) Inventors: Steve Crossan, Paris (FR); Ujjwal Singh, Mountain View, CA (US)

(73) Assignee: GOOGLE INC., Mountain View, CA (US)

(21) Appl. No.: 13/365,507

(22) Filed: Feb. 3, 2012

Related U.S. Application Data
(60) Provisional application No. 61/439,832, filed on Feb. 4, 2011.
(60) Provisional application No. 61/442,168, filed on Feb. 11, 2011.

(51) Int. Cl. H04M 1/64; G10L 21/02; G10L 15/26

(52) U.S. Cl. 379/88.01; 704/235; 704/226; 704/E15.043

(57) ABSTRACT

Methods, systems, and computer program products are provided for generating and posting messages to social networks based on voice input. One example method includes receiving an audio signal that corresponds to spoken content, generating one or more representations of the spoken content, and causing the one or more representations of the spoken content to be posted to a social network.

### CROSS-REFERENCE TO RELATED APPLICATIONS

This application claims the benefit of U.S. Provisional Patent App. No. 61/439,832, filed Feb. 4, 2011, and U.S. Provisional Patent App. No. 61/442,168, filed Feb. 11, 2011, the disclosures of which are incorporated herein by reference.

### BACKGROUND

Users post messages to social networks by, for example, submitting a “status update,” broadcasting a “tweet,” or publishing information on a profile page or “wall.” A user typically posts a message by using a computer and a computer network to log into a social network, typing the message into a web-based interface that is generated by the social network, and selecting a control on the web-based interface to indicate that the message is to be posted to the social network.

Posted messages, which are typically text-based, are often displayed on a web page or within a mobile application (or “app”), where they may be read or otherwise consumed by the public or by a group of other users. A message may be displayed, for example, on a user's profile page, a message feed, or to an online forum, to broadcast information concerning the user. Messages posted to online forums, such as online chat rooms or conversation facilities, can be used to conduct virtual conversations regarding particular topics that may be of interest to visitors of those forums.

### SUMMARY

According to one general implementation, a user may post a message to a social network without using a computer and without requiring access to a computer network. Specifically, the user calls a pre-designated telephone number to interact with an automated message posting system using a telephone, then speaks the message that is to be posted to the social network, optionally adds context to the message (e.g., through interactive voice response system), listens to or otherwise interacts with other messages, and then terminates the call.

The spoken message may be processed by the automated message posting system, for example to convert the spoken content to text, to enhance the audio characteristics of the spoken message, to filter the message (e.g, for duplicate or inappropriate content), to delete the message, to highlight or promote the message, to archive the message, to forward the message to a particular recipient or a group of recipients, to generate links to or other representations of the spoken content, to determine the quality of the message, to select an appropriate forum, forums, page or pages to post the message, to insert content (e.g., topic identifiers) into the message, to determine the identity of the user, to identify a telephone number associated with a telephone connection through which the spoken content was spoken, to identify other messages that are similar to the message, to adjust a score associated with the message or the user, to determine a location associated with the message, to determine advertising content associated with the message, to select one or more social networks to post the message, to identify and/or obtain other content related to the message, to anonymize the message, or to select recipients of the message. The automated message posting system may or may not use any user-provided context information in processing the message.

A representation of the message, which may be the message itself, a processed version of the message, content associated with or derived from the message, and/or a reference (e.g., a hyperlink) to the message, can be posted to the social network by the automated message posting system. The representation of the message may be posted to a page, screen, or view associated with the user (e.g., the user's home page or profile page), to a page, screen, or view associated with a topic of the message, or to one or more other pages, screens, or views that are selected by the automated message posting system.

In addition to posting messages, a user may interact with posted messages using the automated message posting system by, for example, instructing the automated message posting system to read messages over a telephone connection, to rate messages, to reply to posted messages, or to otherwise mark posted messages (e.g., to mark a posted as important or as spam).

The automated message posting system may be used to post messages to a social network, and to consume posted messages, in situations where the user might not otherwise be able to interact with a social network. Messages may be posted to a social network or consumed when, for example, the user does not have access to a computer or a computer network, in contexts where using a computer to post messages is impractical or inconvenient (e.g., due to a small screen or keyboard, or because a complex writing system makes typing difficult), or where the user lacks the computer literacy to post messages using a computer. Furthermore, automated message posting may be used where the user is more comfortable using a telephone than a computer, or where network access or access to the social network is interrupted (e.g., blocked, or blacked out).

Furthermore, the automated message posting system may post or read messages without generating information that may electronically tie the posted message to a particular user or computer, thereby providing an enhanced layer of anonymity over traditional, computer-based message posting techniques. Such anonymity may enhance the user's freedom of expression, particularly in situations where access to computers, computer networks, or social network sites is intentionally blocked or prohibited.

In general, one innovative aspect of the subject matter described in this specification may be embodied in methods, systems, and computer program products for generating and posting representations of spoken content. One example method includes receiving an audio signal that corresponds to spoken content, generating one or more representations of the spoken content, and causing the one or more representations of the spoken content to be posted to a social network.

In general, another innovative aspect of the subject matter described in this specification may include a system which can include one or more computers and a non-transitory computer-readable storage medium coupled to the one or more computers. The storage medium can include stored instructions which, when executed by the one or more computers, cause the one or more computers to perform operations including receiving an audio signal that corresponds to spoken content, generating one or more representations of the spoken content, and posting the one or more representations of the spoken content to a social network.

In general, another innovative aspect of the subject matter described in this specification may include a computer-readable storage device which can be encoded with a computer program. The program can include instructions that when executed by a data processing apparatus cause the data processing apparatus to perform operations including receiving an audio signal that corresponds to spoken content, generating one or more representations of the spoken content, and posting the one or more representations of the spoken content to a social network.

These and other embodiments may include none, one, or more of the following features. In various examples, a telephone connection can be established, sounds that comprise the spoken content can be detected over the telephone connection, and the sounds can be encoded into the audio signal. The audio signal can be received over a computer network. The audio signal can be received over a network that is not a computer network. The audio signal can be received over a telephone network. Speech recognition can be performed on the audio signal to generate a textual representation of the spoken content, and the textual representation of the spoken content can be posted. A hyperlink to the audio signal can be generated, and the hyperlink to the audio signal can be posted.

The representation can be generated using an automated speech recognition (ASR) engine. Generating the one or more representations of the spoken content can include converting the spoken content to text. Generating the one or more representations of the spoken content can include enhancing the audio characteristics of the audio signal. Generating the one or more representations of the spoken content can include filtering the spoken content. Filtering the spoken content can include detecting duplicate content or blacklisted content, and filtering the duplicate content or blacklisted content. Generating the one or more representations of the spoken content can include deleting one or more portions of the spoken content. Generating the one or more representations of the spoken content can include highlighting the representation of the spoken content. Generating the one or more representations of the spoken content can include archiving the audio signal. Generating the one or more representations of the spoken content can include generating a reference to the audio signal. The reference can include a hyperlink. Generating the one or more representations of the spoken content can include determining a quality of the spoken content. Generating the one or more representations of the spoken content can include selecting a forum, forums, page or pages to post the representation. The representation may be posted to the selected feed, feeds, forum, forums, page, or pages only. Generating the one or more representations of the spoken content can include inserting content into the representation of the spoken content. The inserted content can include a hashtag. Generating the one or more representations of the spoken content can include determining an identity of the speaker of the spoken content. Generating the one or more representations of the spoken content can include identifying other audio signals that are similar to the received audio signal. Generating the one or more representations of the spoken content can include adjusting a score associated with the representation of the spoken content. Generating the one or more representations of the spoken content can include determining a location associated with the spoken content. Generating the one or more representations of the spoken content can include determining advertising content associated with the spoken content. Generating the one or more representations of the spoken content can include obtaining other content related to the spoken content. Generating the one or more representations of the spoken content can include anonymizing the spoken content. Generating the one or more representations of the spoken content can include selecting recipients of the representation of the spoken content.

An interface can be provided by the social network, and the audio signal can be received through the interface. An audio signal can be transmitted that corresponds to different content that has been posted to the social network. A telephone keypad selection can be detected, and the forum, forums, page or pages can be selected based on the selection. A telephone number associated with a telephone call through which the audio signal is received can be identified, and the forum, forums, page or pages can be selected based on the telephone number. The telephone number can be the telephone number associated with the caller. The telephone number can be the telephone number associated with the callee.

The representation of the spoken content can be posted using one or more computers. One or more representations can be posted to a message feed or profile page on the social network. One or more representations of the spoken content can be automatically posted to the social network by an automated message posting system.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a diagram of an example system that can receive audio signals corresponding to spoken content and can post representations of the spoken content to social networks.

FIG. 2 is a flowchart of an example process for receiving audio signals corresponding to spoken content and posting representations of the spoken content to social networks.

FIG. 3 is a screenshot of a user interface which displays several posted messages, including messages that were posted by an automated message posting system using spoken content

FIG. 4 is a diagram of example interfaces for posting and presenting messages based on spoken content.

FIG. 5 shows example interactions between a user and an automated message posting system using spoken content.

FIG. 6 shows an example of a computer device and a mobile computer device that can be used to implement the techniques described here.

Like reference symbols in the various drawings indicate like elements.

### DETAILED DESCRIPTION

In general, users can post messages to social networks by calling an automated message posting system by using telephone or through any audio interface, such as an audio interface provided by a social network or third party. Spoken content can be stored and converted to text, or links associated with spoken content can be generated. A representation of the spoken content can be published to social networks for access by other users.

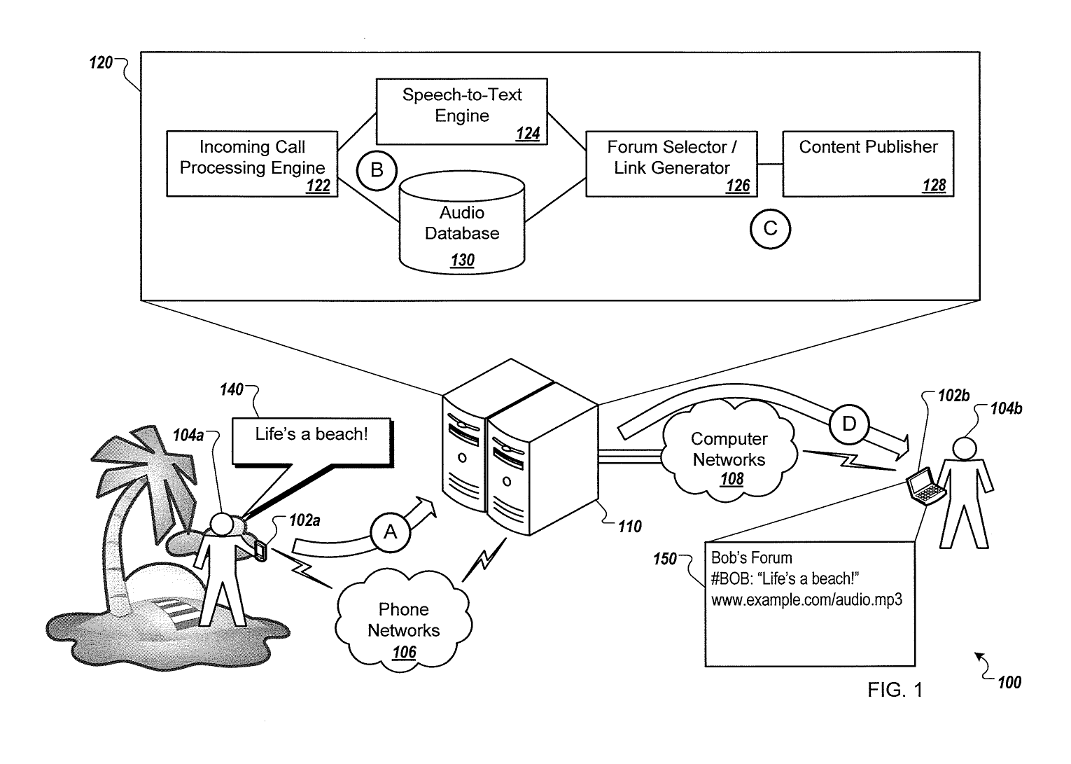

FIG. 1 is a diagram of an example system 100 that can receive audio signals corresponding to spoken content, can post representations of the spoken content to social networks, and can allow a user to interact with posted representations. FIG. 1 also illustrates an example flow of data within the system 100 during states (A) to (D), where the states (A) to (D) may occur in the illustrated sequence, or they may occur in a sequence this is different than in the illustrated sequence.

In further detail, the system 100 includes one or more client computing devices 102 (each operated by a corresponding user 104) that communicates over one or more phone networks 106 and/or computer networks 108 with one or more computing servers 110. The phone networks 106 may include a wireless cellular network, a wireless local area network (WLAN) or WiFi network, a Third Generation (3G) or Fourth Generation (4G) mobile telecommunications network, or any appropriate combination thereof. The computer networks 108 may include private networks such as an intranet, public networks such as the Internet, or any appropriate combination thereof. In other implementations, the phone networks 106 may include computer networks through which audio signals such as telephone calls can be communicated.

The client device(s) 102 may be any appropriate type of computing device (e.g., mobile phone, smart phone, PDA, music player, e-book reader, tablet computer, laptop or desktop computer, or other stationary or portable device) that includes one or more processors and computer readable media. Among other components, for example, the client device(s) 102 includes one or more processors, computer readable media that store software applications, input device(s) (e.g., touch screens, keyboards, computer mice, motion sensors, microphones, and the like), output device(s) (e.g., display screens, speakers, and the like), and communications/network interfaces. In other implementations, the client device(s) 102 may be a landline telephone.

The computing server(s) 110 may be configured to execute application code associated with a variety of software components (e.g., modules, objects, libraries, services, and the like) for implementing an automated message posting system 120, including an incoming call processing engine 122, a speech-to-text engine 124, a forum selector/link generator 126, and a content publisher 128. Although the system 120 is referred to by this disclosure as an automated message posting system, the system 120 may perform functions other than posting messages, such as reading the messages or transcriptions of the messages, deleting messages, filtering messages, marking or tagging messages, or other functions.

Two or more of the components 122, 124, 126, and 128 may be implemented on the same computing device, or on different computing devices, such as devices included in a server farm or a peer-to-peer network. The server(s) 110 can be in communication with one or more data storage devices, including an audio database 130, which can implement databases, file systems, and the like to add and maintain data (e.g., audio recordings) used by the system 100.

Referring to the example flow of data, during state (A), an audio signal that corresponds to spoken content can be received. For example, the initiating user 102a (e.g., “Bob”) can use the client computing device 104a to place a call to the automated message posting system 120 implemented by the computing server(s) 110. As a computer network may not be required between the device 104a of the user 102a and the automated message posting system 120, in some implementations, the initiating user's device 102a may be a conventional telephone or feature phone that does not communicate with the automated message posting system 120 over a computer network connection. In some implementations, a social network may provide one or more phone numbers enabling users to contact the automated message posting system 120 and provide voice messages. Upon accessing the message posting system 120, for example, the user 104a can utter a message 140 (e.g., “Life's a beach!”) to be posted to the social network.

During state (B), a representation of (e.g., a hyperlink to) the spoken content can be generated. For example, the incoming call processing engine 122 can receive the spoken content provided by the user 104a. In some implementations, the spoken content can be converted to text. For example, the spoken content can be provided to the speech-to-text engine 124, which can execute one or more speech recognition algorithms for converting the content. In some implementations, the spoken content can be stored. For example, the spoken content can be stored in audio database 130 with voice messages provided by other users 104.

During state (C), the representation of the spoken content can be posted to a social network. For example, the forum selector/link generator 126 can select one or more social networks for posting representations (e.g., text, links to stored voice messages) of the spoken content. The content publisher 128 can interface with the social network(s) and can post the representations, for example, using social networking APIs (Applications Programming Interfaces). As another example, the content publisher 128 can post and provide representations of content directly to system users. Causing the representation to be posted may include posting the representation, or generating or transmitting a signal or instruction for a message posting system to post the representation on a social network.

During state (D), the representation of the spoken content can be provided to users. For example, the user 104b (e.g., “Ed”) can employ the client computing device 102b to access the social network (e.g., via a web browser) via the computer networks 108, and to access a representation 150 of the message provided by the user 104a (e.g., “Bob”). For example, the representation 150 can include converted text (e.g., “Life's a beach!”) associated with the spoken content provided by the user 104a and/or a hyperlink to the spoken content stored at the audio database 130. As another example, the representation can include playback of archived audio associated with the provided message.

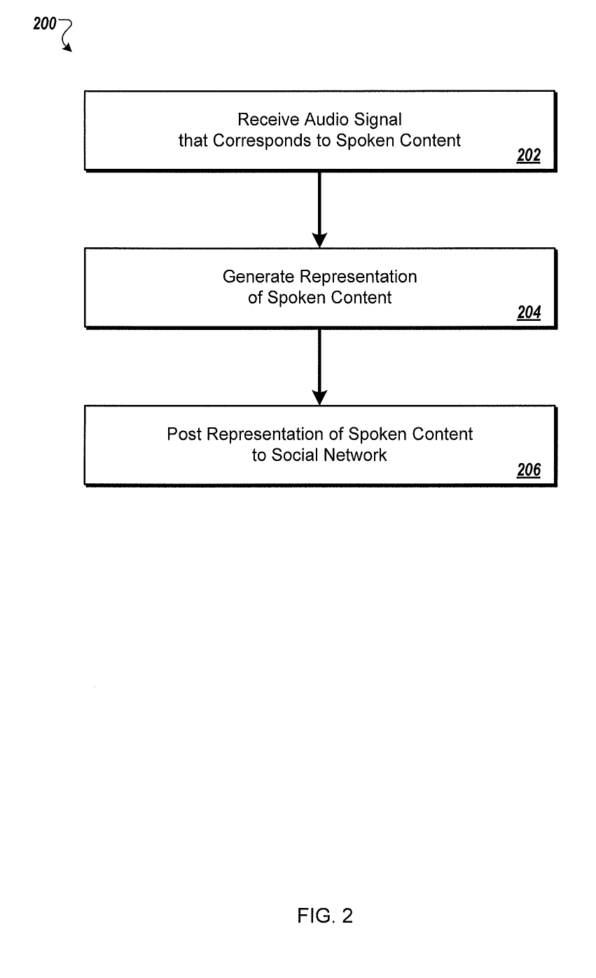

FIG. 2 is a flowchart of an example process 200 for receiving audio signals corresponding to spoken content and posting representations of the spoken content to social networks. In some implementations, the process 200 may be performed by the system 100, and will be described as such for the purpose of clarity. Briefly, the process 200 includes receiving an audio signal that corresponds to spoken content, generating a representation of the spoken content, and posting the representation of the spoken content to a social network.

In more detail, an audio signal that corresponds to spoken content can be received (202). For example, the automated message posting system 120 can employ the incoming call processing engine 122 to process a telephone call from the user 104a using the client computing device 102a (e.g., a cell phone). In some implementations, processing the telephone call can include establishing a telephone connection, detecting, via the telephone connection, sounds or utterances that include spoken content, and encoding the sounds into an audio signal. A telephone connection between the client device 102a and the computing server(s) 110 can be maintained by the phone networks 106, for example. Thus, in some implementations, the device used by an initiating user (e.g., the user 104a) to connect to the computing server(s) 110 may be a conventional telephone or a feature phone that does not communicate over a computer network connection.

In some implementations, the automated message posting system 120 may include message forum/social networking features, such as message posting and retrieval, user account maintenance, group creation, and the like. For example, telephone-based systems may be used in areas with limited data connectivity, limited literacy, or when the use of keyboards is limited or difficult. In some implementations, telephone-based systems may be employed in conjunction with computer network systems. For example, messages can be provided and accessed through telephone interfaces, and the messages (or representations of the messages) can also be provided and accessed through computer network interfaces. A user could, for example, provide and receive messages using either or both interfaces.

A representation of the spoken content can be generated (204). For example, the automated message posting system 120 can generate a representation of spoken content (e.g., a voice message) provided by the user 102a using various software modules and/or sources of data.

In some implementations, generating the representation may include enhancing the audio characteristics of the audio signal. For example, background noise can be reduced or eliminated by the incoming call processing engine 122. As another example, the incoming call processing engine 122 can normalize the audio signal, to maintain consistent audio qualities (e.g., volume) among signals provided by various users.

In some implementations, speech recognition can be performed on the audio signal to generate a textual representation of the spoken content. For example, the speech-to-text engine 124 (e.g., an automated speech recognition engine) can convert the audio signal to a representation of the spoken content including textual content (e.g., words spoken by the user 102a).

In some implementations, generating the representation may include archiving the audio signal. For example, audio signals associated with spoken content provided by multiple users 102 can be archived by the audio database 130, for subsequent retrieval and/or for use in further processing. In some implementations, a reference to the audio signal can be generated. For example, the forum selector/link generator 126 can generate references to audio signals archived by the audio database 130 for use by further processes and/or to enable users 102 to access the signals. The reference, for example, can include a hyperlink.

In some implementations, generating the representation may include identifying other signals that are similar to the received signal. For example, the incoming call processing engine 122 can access the audio database 130 to identify one or more previously stored signals to identify similar signals. Similarity, for example, may include aspects such as message length, message content, and message quality.

In some implementations, generating the representation may include determining a quality of the spoken content. For example, quality of the audio signal associated with the spoken content may be determined by the automated message posting system 120. As another example, the automated message posting system 120 can analyze converted text associated with the spoken content to determine conformance to grammar rules, avoidance of profanity, or other such indications of quality.

In some implementations, generating the representation may include adjusting a score associated with the representation. For example, the automated message posting system 120 can associate scores with received messages. Thus, messages associated with high-quality audio signals and/or text content may receive high scores, and messages associated with low-quality audio signals and/or text content may receive low scores.

In some implementations, generating the representation may include filtering the spoken content. For example, the automated message posting system 120 can detect duplicate content or blacklisted content, and such content can be filtered. To detect duplicate content, for example, the automated message posting system 120 can compare incoming audio signals with stored signals, or can compare text associated with incoming messages to previously published text. Blacklisted content, for example, may include blacklisted message text (e.g., profanity), content associated with blacklisted users (e.g., trolls), or other unsuitable content.

In some implementations, one or more portions of the spoken content may be deleted. For example, the speech-to-text engine 124 can delete profanity from user messages. As another example, profanity may be replaced by placeholder words, sounds, or symbols. As another example, portions of audio signals stored by the audio database 130 may be muted.

In some implementations, generating the representation may include highlighting the representation of the spoken content. For example, the speech-to-text engine 124 can highlight (e.g., modify colors, change fonts, italicize, bold, etc.) particular sections of text which may be of interest to one or more users. As another example, hyperlinks may be added for particular words included in the message.

In some implementations, generating the representation may include determining an identity of the speaker of the spoken content. For example, the incoming call processing engine 122 can access a database of user phone numbers (not shown) to determine the identity of the user 104a. As another example, the incoming call processing engine 122 can access the audio database 130 to compare the voice signature of the user 104a with voice signatures of previous callers. As another example, the user 104a may identify him/herself by providing identification (e.g., a code).

In some implementations, generating the representation may include anonymizing the spoken content. For example, audio signals stored by the audio database may be distorted such that the identity of users 104 providing messages may be undeterminable. As another example, text generated by the speech-to-text engine 124 may or may not be attributed to any particular user.

In some implementations, generating the representation may include determining a location associated with the spoken content. For example, the speech-to-text engine 124 can identify message text keywords associated with particular locations (e.g., countries, states, cities, neighborhoods, places of business). As another example, the a client computing device 102a and/or the phone networks 106 may provide information (e.g., IP addresses, GPS location information, country code information, antenna tower information, etc.) that may be used by the automated message posting system 120 to identify the present physical location of the user. As another example, the user 104a may directly provide such location information via a location reporting application executed by the client computing device 102a. In some implementations, if the location of an initiating user is determined (e.g., using caller identification technology), the automated message posting system 120 may add a note or hashtag specifying the location.

In some implementations, generating the representation may include inserting content into the representation of the spoken content. For example, the automated message posting system 120 may identify information associated with the spoken content, and insert the content into the representation. Inserted content, for example, may be related to the spoken content, and may include text, graphics, video, sound, and other content types. In some implementations, advertising content associated with the spoken content can be determined. For example, considering the voice message 140 (e.g., “Life's a beach!”) provided by the user 104a, content associated with beaches (e.g., a hyperlink to a website for beach vacations) may be inserted into the representation of the spoken content. As another example, if the particular location (e.g., the particular beach) of the user 104a is determined, content associated with the location (e.g., an advertisement for a resort near the particular beach) can be inserted into the representation.

In some implementations, generating the representation may include selecting recipients of the representation of the spoken content. For example, the user 104a (e.g., “Bob”) may have identified one or more other users (e.g., user 104b, “Ed”), for receiving representations of his spoken content, and the automated message posting system 120 can provide representations to such users. The representations, for example, can be provided by communications mechanisms such as e-mail, text messages, web sites, forums, and social networks.

In some implementations, generating the representation may include selecting a feed, feeds, forum, forums, page or pages to post the representation. For example, the forum selector/link generator 126 can select one or more places for posting the representation (e.g., converted text and/or link to audio) of the spoken content provided by the user 104a. In some implementations, the representation may be posted to the selected feed, feeds, forum, forums, page, or pages only. For example, the user 104a may select desired places for posting. As another example, the automated message posting system 120 may select such places.

The representation of the spoken content can be posted (206) to a social network. In some implementations, textual representations of spoken content may be posted. For example, the content publisher 128 can post a textual representation of spoken content (e.g., “Life's a beach!”) provided by the user 104a. In some implementations, links to audio signals may be posted. For example, the content publisher 128 can post a hyperlink to an audio file of the user 104a speaking the phrase, “Life's a beach!” The content publisher 128 may interface with various pages, forums, and social networks, for example, using APIs provided by the entities.

In some implementations, the representation of spoken content may be posted to a message feed or profile page on the social network. For example, the content publisher 128 can post a representation of spoken content associated with the user 104a to a message feed or profile page of the user 104a, if identity information for the user 104a is available.

In some implementations, the representation of the spoken content may be automatically posted to one or more social networks by an automated message posting system. For example, the automated message posting system 120 can post representations of spoken content automatically.

In some implementations, a telephone keypad selection may be detected, and one or more forums and/or pages may be selected based on the telephone keypad selection. For example, the user 104a can use a keypad of the client computing device 102a to provide codes or menu selections to the computing server(s) 110 for accessing particular social networks associated with the automated message posting system 120. As another example, the user 104a can provide spoken commands for indicating desired selections.

In some implementations, a telephone number associated with a telephone call through which the audio signal is received can be identified, and one or more forums and/or pages may be selected based on the telephone number. For example, the automated message posting system 120 can reference and maintain a mapping between phone numbers, users, and forums, pages, and/or social networks.

In some implementations, the telephone number may be a telephone number associated with the caller. For example, caller identification information associated with the device 102a (e.g., a telephone) may be referenced by the incoming call processing engine 122 to identify one or more forums, pages, and/or social networks associated with the user 104a. The user 104a, for example, may use an interface to the automated message posting system 120 to specify particular forums, pages, and/or social networks of interest.

In some implementations, the telephone number may be a telephone number associated with the callee. For example, the incoming call processing engine 122 can identify the number called by the user 104a to identify one or more forums, pages, and/or social networks associated with the number. Different social networks or different social networking accounts may be associated with different numbers, for example. In some implementations, multiple numbers may be used for accessing a message forum or social network, and the particular number called by a user to access the forum may be used to designate an area of interest within the forum or social network. For example, users of a message forum related to sports may call a particular number to post and receive messages for a particular team. Message postings related to the team can include an identifier, such as a hashtag, for example.

In some implementations, an interface may be provided by the social network, and the audio signal may be received through the interface. For example, the automated message posting system 120 can include social networking capabilities such as message posting, user account maintenance, group creation, user promotion and/or demotion of posted messages, and the like. In some implementations, the automated message posting system 120 may provide web-based interfaces to users 104 via web browsers executed by client computing devices 102, allowing users 104 to provide and receive messages. In some implementations, the automated message posting system 120 may provide voice interfaces allowing users 104 to use telephones to provide and receive messages via various menu options.

In some implementations, an audio signal may be transmitted that corresponds to different content that has been posted to the social network. For example, the user 104a can employ the device 102a (e.g., a telephone) to interact with (e.g., to receive, forward, reply to, rate, mark as spam, etc.) messages posted by other users 104. By using a keypad of the device 102a, for example, audio tones can be generated and provided to the incoming call processing engine 122, and various message interaction functions can be triggered. Thus, for example, social network users can publicly and/or privately respond to each other's messages, can collaboratively promote certain messages (e.g., interesting or important messages), and can collaboratively demote certain messages (e.g., spam).

To promote (e.g., indicate approval of, to indicate interest in, etc.) or demote (e.g., indicate disapproval of, indicate disinterest in) a posted message, for example, the user 104a may first listen to the posted message, then employ the device 102a (e.g., a telephone) to provide information indicative of an intent to promote or demote the message. For example, the user 104a may use a keypad of the device 102a to enter a code (e.g., “1 to promote, 2 to demote”), or may utter a command word or phrase (e.g., “interesting”, “boring”, “important”, “spam”, etc.). In the present example, the incoming call processing engine 122 can receive the information provided by the user 104a, and the automated message posting system 120 can use the information to maintain statistics associated with particular messages and/or users. If a particular message is collaboratively promoted (e.g., is promoted by a threshold number of users, is associated with a threshold percentage of promotions relative to demotions, etc.), in some implementations, the message may be elevated when presenting messages to users. For example, the automated message posting system 120 may provide (e.g., play, present in a list, etc.) collaboratively promoted messages before providing non-promoted messages. If a particular message is collaboratively demoted (e.g., is demoted by a threshold number of users, is associated with a threshold percentage of demotions relative to demotions, etc.), in some implementations, the message may be suppressed when presenting messages to users. For example, the automated message posting system 120 may provide demoted messages after providing promoted messages, or may filter demoted messages.

In some implementations, collaborative filtering techniques may be used when elevating promoted messages and/or suppressing demoted messages for particular users. For example, the user's 104a patterns of promoting and demoting messages may be compared to the patterns of other users to identify users with similar message preferences. Upon determining the user's 104a preferences, for example, the automated message posting system 120 may use the preferences when determining which messages to elevate or suppress. Messages that are promoted by other users with preferences similar to that of the user 104a may be elevated for the user 104a, for example, whereas messages that are demoted by such users may be suppressed.

In some implementations, particular users may be promoted or demoted. For example, upon listening to a message provided by another user of the automated message posting system 120, the user 104a may choose to generally promote or demote the other user. Thus, in some implementations, users may choose to “subscribe” to messages posted by some users, and may choose to “block” messages posted by others.

In some implementations, the promotion or demotion of a message or user by users of one class of devices may be considered when presenting messages to users of another class of devices. For example, if the user 104a were to use the device 102a (e.g., a telephone) to promote (or demote) a particular message, the message may be elevated (or suppressed) when presenting messages to the user 104b of the device 102b (e.g., a client computing device). Similarly, if the user 104b were to use the device 102b to promote or demote a particular message, the message may be elevated or suppressed when presenting messages to the user 104a of the device 102a.

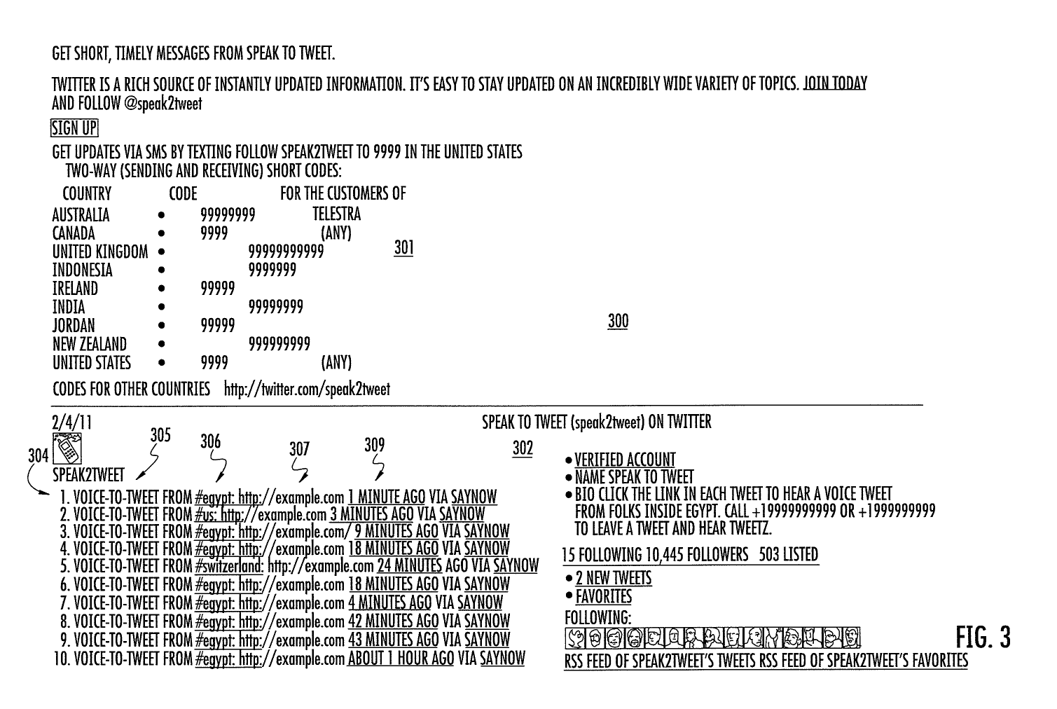

FIG. 3 is a screenshot of a user interface 300 that includes a message feed region 302 which displays several posted messages, including messages that were posted by an automated message posting system using spoken content. Specifically, the user interface 300 includes a contact information region 301 that displays contact information (e.g., telephone numbers) that users may use to speak content that they would like to have posted on the social network, and the message feed region 302 that displays representations of posted messages.

The message feed region 302 displays a representation 304 of a message that was posted by an automated message posting system using spoken content. The representation 304 includes text 305 (in the figure, “voice-to-tweet from”) that identifies the message as a message that was initiated using spoken content. The representation 304 also includes hashtag 306 (in the figure, “#egypt”), which identifies a topic or originator of the message, as well as a hyperlink 307 (“in the figure, “http://example.com”), which links to the audio signal corresponding to the spoken content, a textual transcription of the spoken content, or some other content related to the spoken content. The representation 304 also includes timestamp information 309 that indicates when the spoken content was spoken, or when the automated message posting system posted the representation 304.

The message feed region 302 may display other information in association with each messages, or some messages. For instance, the message feed region may also display information indicating that the message has a high or low quality score or priority (e.g., through the use of highlighting or different font styles), information indicating that the message is recent or old, images associated with the message (e.g., of the user that spoke the spoken content, of content associated with the topic of the spoken content), textual information identifying the user that spoke the spoken content, a score or rating associated with the message, advertising content or sponsored content, a list of recipients of the message, or other information. The information displayed in association with each message may be automatically selected by a system such as the automated message posting system, by the user that spoke the spoken content, or by a viewer or group of viewers of the message.

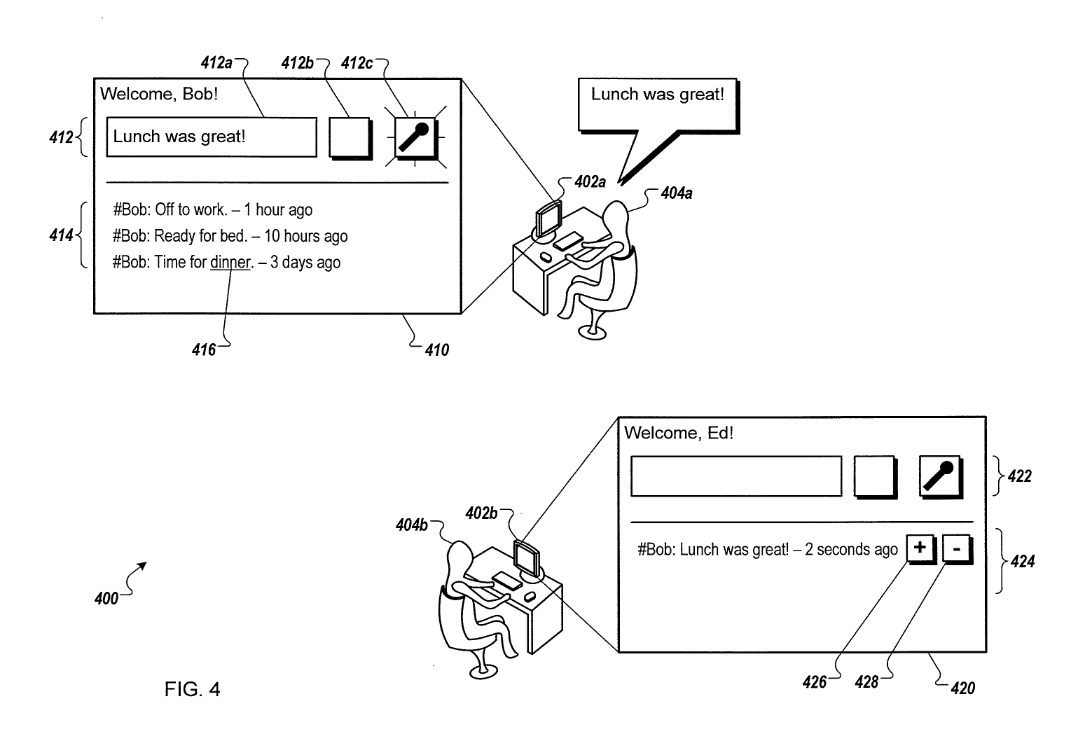

FIG. 4 is a diagram of example interfaces 400 for posting and presenting messages based on spoken content. Referring to example interface 410 (e.g., a social networking interface presented by a web browser), messages can be posted to a forum, forums, a page, or pages. Referring to example interface 420 (e.g., another social networking interface), posted messages can be presented to one or more users.

In the present example, the interface 410 can be presented by a client computing device 402a operated by a user 404a (e.g., “Bob”). For example, the user 404a can use a web browser executed by the client computing device 402a to navigate to a web page associated with a social network. Upon logging into the social network, for example, the user 404a can be presented with the interface 410 including controls 412 for providing spoken and/or other (e.g., textual, graphical, embedded, linked, etc.) content to an automated message posting system (e.g., the automated message posting system 120, shown in FIG. 1) for posting to one or more forums and/or pages.

In some implementations, the interface 410 may include a message presentation area 414 for presenting representations of messages previously provided by the user 404a and/or other users. For example, the representations can include user identifiers (e.g., hashtags), textual representations of spoken content, and posting time information. In some implementations, the representations can include linked or embedded content. For example, upon providing a spoken message (e.g., “Time for dinner.”), the user 404a may indicate additional content (e.g., a dinner recipe, a photo, etc.) associated with the message, and the automated message posting system 120 can insert the content into the representation of the message via a hyperlink or some other mechanism.

To provide spoken content, in some implementations, the user 404a may interact with an audio input control 412c. In the present example, the user 404a can provide spoken content (e.g., “Lunch was great!”) via a microphone associated with the client computing device 402a. In some implementations, a textual representation of the spoken content may be generated and presented to the user via a text control 412a for verification by the user 404a.

Upon verification, for example, the user 404a can provide content to the automated posting system 120 by interacting with a submission control 412b. As another example, upon verification, the user 404a can provide additional content to be inserted into the representation of the spoken content by interacting with additional controls 412. In some implementations, messages may be provided without verification by the user 404a. For example, the user 404a can interact with the submission control 412b upon completing his or her message. As another example, the interface 410 can provide spoken content to the automated posting system 120 when an audio signal associated with the content meets a certain condition (e.g., when the user 404a stops speaking or speaks a particular word or phrase).

In the present example, the message (e.g., “Lunch was great!”) provided by the user 404a can be posted by the automated posting system 120 for presentation to one or more other users (e.g., user 404b, “Ed”). For example, the user 404b can use a client computing device 402b to interact with the interface 420 for receiving representations of spoken content provided by other users and for providing spoken content messages. Similar to the interface 410, for example, the interface 420 may include a message presentation area 424 for presenting representations of messages previously provided by the user 404b and/or other users. Upon receiving such representations, for example, the user 404b can interact with controls 422 for providing additional spoken content messages. Thus, multiple users may engage in message conversations. The presentation area 424 in the present example may also include controls 426, 428 for indicating an intent to promote or demote a message. For example, if the user 404b (“Ed”) considers Bob's message (e.g., “Lunch was great!”) to be important or interesting, the user 404b may interact with (e.g., click) the control 426 to promote the message. However, if Ed considers Bob's message to be unimportant, for example, he may interact with the control 428 to demote the message.

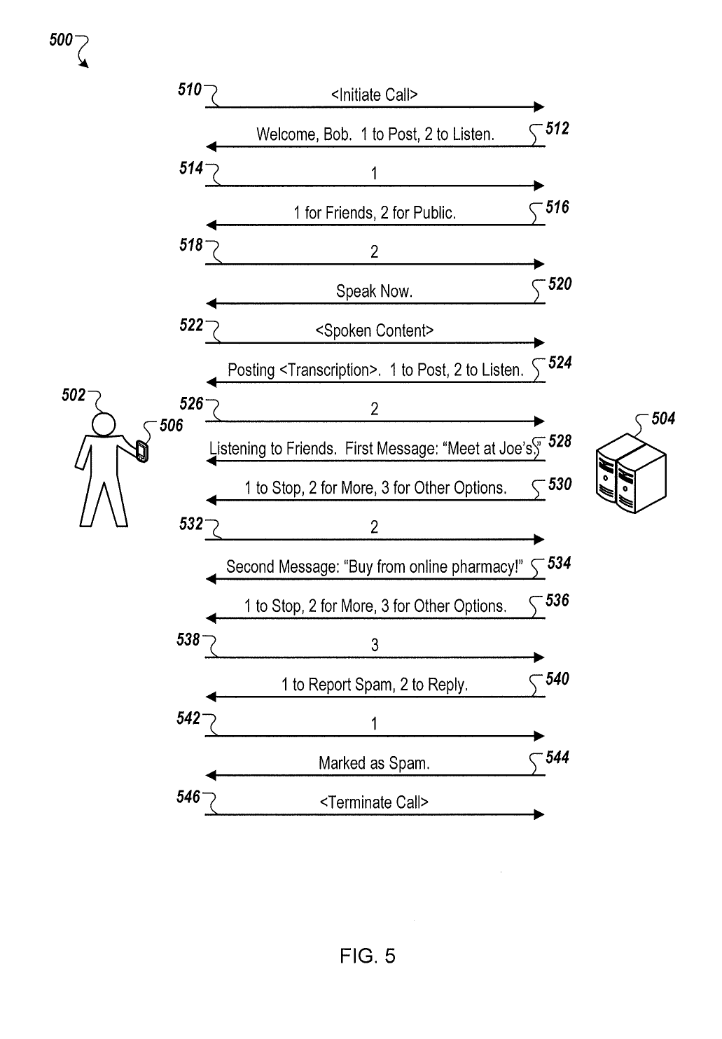

FIG. 5 shows example interactions 500 between a user 502 and an automated message posting system 504 using spoken content. To engage in such interactions, for example, the user 502 can employ a communications device 506, such as a landline or mobile telephone, a feature phone, a smartphone, or a computing device including a microphone and speaker. In general, the automated message posting system 504 can receive audio signals that correspond to spoken content, generate representations of the spoken content, and can post the representations of the spoken content to one or more social networks. In some implementations, a voice network may serve as a social network. Thus, the user 502 may provide and receive messages in areas where data networks are not present, in situations where literacy is not universal, or in areas where the character set of a particular language is difficult to implement on a keyboard device.

Referring to the example interactions 500, the user 502 can employ the communications device 506 to initiate a call (510) with the automated message posting system 504. For example, the user 502 can dial a telephone number associated with a particular social network. In some implementations, different phone numbers may be associated with different social networking accounts, forums, or groups. For example, a number may be associated with a forum related to a natural disaster, and another number may be associated with forum related to an election event. In some implementations, phone numbers may be geographically distributed to allow for local access. For example, the election event may be associated with multiple numbers, each for a different region participating in the election.

The automated message posting system 504 can receive the call, and can select one or more forums or pages, based at least in part on the telephone number. In some implementations, the system 504 can recognize the user 502, based on caller ID, a code entered by the user via a keypad or speech, voice recognition, or another appropriate mechanism, and can provide the user 502 with a prompt message (512) “Welcome, Bob. 1 to Post, 2 to Listen.” In the present example, Bob makes a selection (e.g., by keypad or speech) of “1”, or “Post” (514). Upon receiving the selection, the system 504 can provide another prompt message (516) “1 for Friends, 2 for Public.” Thus, in some implementations, users may indicate whether spoken content messages are intended for distribution to particular individuals, particular groups of individuals, or for general broadcast within a social network. In the present example, Bob makes a selection of “2”, or “Public” (518), and the system 504 provides a prompt message (520) for Bob to begin providing his message.

The user 502 can provide a message (522) via spoken content. The automated message posting system 504, for example, can receive an audio signal corresponding to the spoken content, can generate a representation of the spoken content, and can post the representation of the spoken content to the social network. In some implementations, speech recognition can be performed on the audio signal to generate a textual representation of the spoken content. For example, the system 504 can transcribe the spoken content and can provide the transcription (524) to the user 502 for verification.

Thus, in some implementations, audio recordings of spoken content and textual representations can be generated and provided to users in various formats. For example, audio recordings may be provided to users accessing the social network with a telephone device, and textual representations (i.e., transcriptions) may be provided to users accessing the social network via a web browser. In some implementations, message translation may be provided. For example, the system 504 can receive spoken content, can generate a textual representation of the spoken content, can translate the textual representation to another language, and can provide the translated representation via text and/or computer-generated speech

In the present example, Bob elects not to post his message, but to listen to messages posted by others (526). The automated message posting system 504 can provide Bob with the message (528), “Listening to friends. First message: Meet at Joe's”. The message, for example, may have been previously provided by a user included in Bob's social network, for example, Upon providing the message, for example, the system 504 can provide message-related options (530) “1 to stop, 2 for more, 3 for other options.” In the present example, Bob selects (532) option “2”, or “More”.

Upon receiving Bob's selection, for example, the system 504 provides Bob with a second message (534), “Buy from online pharmacy!”, along with message-related options (536). Bob may identify this message as being an undesirable message (e.g., spam). In the present example, Bob selects (538) option “3”, or “Other Options”, followed by a return prompt (540), “1 to report spam, 2 to reply” from the system 504. As Bob has no intent to directly respond (e.g., either privately or publicly) to the spammer, but does intend to suppress further spam messages, he selects (542) option “1”, or “Report Spam”. If a certain number or percentage of users identifies a particular user as being a spammer, in some implementations, the system may suppress further messages from the user. In the present example, the system 504 provides a confirmation message (544) of “Marked as spam.”. At this point, Bob elects to terminate his call (546), for example, by hanging up.

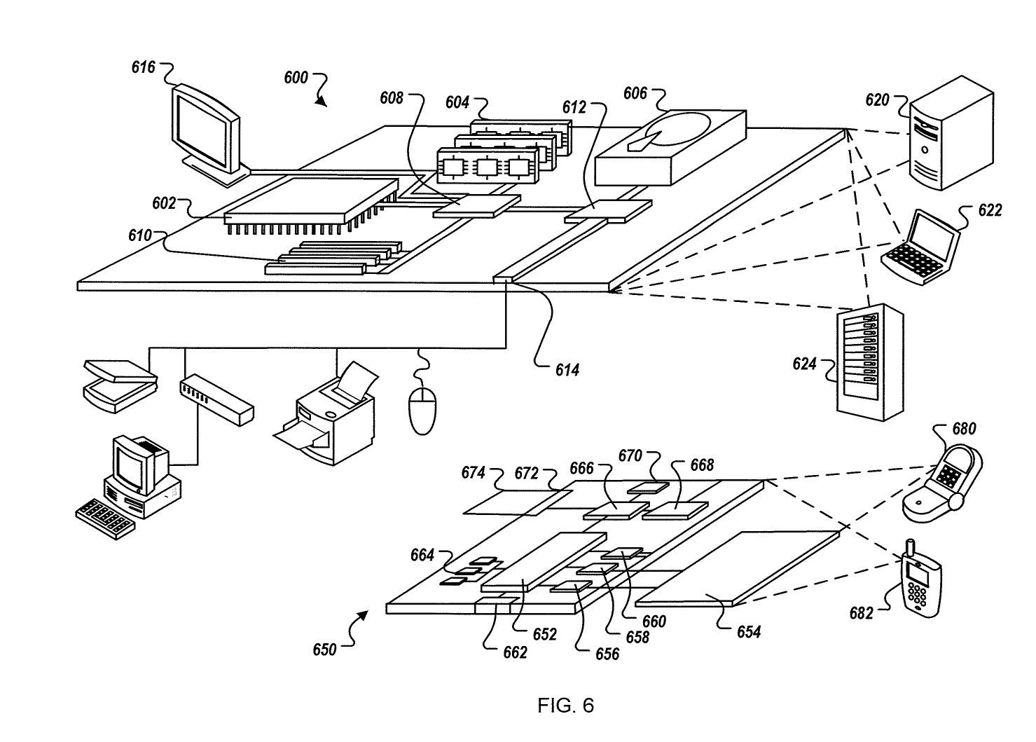

FIG. 6 shows an example of a generic computer device 600 and a generic mobile computer device 650, which may be used with the techniques described here. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be examples only, and are not meant to limit implementations of the technology described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, memory on processor 602, or a propagated signal.

The high speed controller 608 manages bandwidth-intensive operations for the computing device 600, while the low speed controller 612 manages lower bandwidth-intensive operations. Such allocation of functions is solely for purposes of example. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the technology described.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
receiving an audio signal that corresponds to spoken content;
generating one or more representations of the spoken content; and
causing the one or more representations of the spoken content to be posted to a social network.

2. The method of claim 1, comprising:
performing speech recognition on the audio signal to generate a textual representation of the spoken content,
wherein posting a representation of the spoken content comprises posting the textual representation of the spoken content.

3. The method of claim 1, comprising:
generating a hyperlink to the audio signal,
wherein posting a representation of the spoken content comprises posting the hyperlink to the audio signal.

4. The method of claim 1, comprising:
establishing a telephone connection;
detecting, via the telephone connection, sounds that comprise the spoken content; and
encoding the sounds into the audio signal.

5. The method of claim 1, wherein the one or more representations are posted to a message feed or profile page on the social network.

6. The method of claim 1, wherein the one or more representations of the spoken content are automatically posted to the social network by an automated message posting system.

7. The method of claim 1, wherein generating the one or more representations of the spoken content comprises converting the spoken content to text.

8. The method of claim 1, wherein generating the one or more representations of the spoken content comprises enhancing the audio characteristics of the audio signal.

9. The method of claim 1, wherein generating the one or more representations of the spoken content comprises filtering the spoken content.

10. The method of claim 9, wherein filtering the spoken content comprises detecting duplicate content or blacklisted content, and filtering the duplicate content or blacklisted content.

11. The method of claim 1, wherein generating the one or more representations of the spoken content comprises deleting one or more portions of the spoken content.

12. The method of claim 1, wherein generating the one or more representations of the spoken content comprises highlighting the representation of the spoken content.

13. The method of claim 1, wherein generating the one or more representations of the spoken content comprises archiving the audio signal.

14. The method of claim 1, wherein generating the one or more representations of the spoken content comprises generating a reference to the audio signal.

15. The method of claim 14, wherein the reference comprises a hyperlink.

16. The method of claim 1, wherein generating the one or more representations of the spoken content comprises determining a quality of the spoken content.

17. The method of claim 1, wherein generating the one or more representations of the spoken content comprises selecting a forum, forums, page or pages to post the representation.

18. The method of claim 1, wherein the audio signal is received over a telephone network.

19. The method of claim 1, wherein the representation of the spoken content is posted using one or more computers.

20. The method of claim 1, wherein the representation is generated using an automated speech recognition (ASR) engine.

21. The method of claim 1, further comprising:
providing an interface, by the social network,
wherein the audio signal is received though the interface that is provided by the social network.

22. The method of claim 1, wherein the audio signal is received over a computer network.

23. The method of claim 1, comprising:
transmitting an audio signal that corresponds to different content that has been posted to the social network.

24. A system comprising:
one or more computers; and
a non-transitory computer-readable storage medium coupled to the one or more computers having instructions stored thereon which, when executed by the one or more computers, cause the one or more computers to perform operations comprising:
establishing a telephone connection;
detecting an utterance that is spoken over the telephone connection;
encoding the utterance;
generating a hyperlink to the encoded utterance;
detecting a telephone keypad selection;
selecting a social network feed based on the telephone keypad selection; and
posting the hyperlink on the selected feed.

25. The system of claim 24, wherein the hyperlink is posted to selected feed only.

26. The system of claim 24, comprising:
determining a telephone number associated with a telephone connection,
wherein the forum is further selected based on the telephone number.

27. The system of claim 26, wherein the telephone number is the telephone number associated with a caller.

28. The system of claim 26, wherein the telephone number is the telephone number associated with a callee.

29. The system of claim 24, wherein the utterance is received over a network that is not a computer network.

30. A computer-readable storage medium encoded with a computer program, the program comprising instructions that when executed by a data processing apparatus cause the data processing apparatus to perform operations comprising:
storing an audio recording of a caller;
generating data associated with the audio recording, wherein the data comprises a hyperlink to the stored audio recording, or an automatically generated transcription of the audio recording; and
posting the data to a social network profile page or news feed.
